(19) United States
(12) Patent Application Publication
(10) Pub. No.: US 2022/0259421 A1
(43) Pub. Date: Aug. 18, 2022

(54) Thermoplastic Resin Composition and Molded Article Formed Therefrom

(71) Applicant: LOTTE CHEMICAL CORPORATION, Seoul (KR)

(72) Inventors: Jin Seong LEE, Uiwang-si (KR); Hyun Taek JEONG, Uiwang-si (KR); Young Chul KWON, Uiwang-si (KR); Hyun Ji OH, Uiwang-si (KR)

(21) Appl. No.: 17/617,399

(22) PCT Filed: Jun. 29, 2020
(86) PCT No.: PCT/KR2020/008464

§ 371 Date: Dec. 8, 2021

(30) Foreign Application Priority Data
Jul. 30, 2019 (KR) 10-2019-0092222

(51) Int. Cl. C08L 55/02; C08L 25/14; C08L 25/12; C08F 220/32; C08F 222/06; C08K 7/14; C08K 5/521

(52) U.S. Cl. CPC C08L 55/02; C08L 25/14; C08L 25/12; C08F 220/325; C08L 2205/03; C08K 7/14; C08K 5/521; C08L 2201/02; C08L 2201/08; C08F 222/06

(57) ABSTRACT

A thermoplastic resin composition according to the present invention comprises: about 100 parts by weight of a rubber-modified aromatic vinyl copolymer resin; about 5 to about 20 parts by weight of an epoxy group-containing vinyl copolymer; about 0.5 to about 5 parts by weight of a maleic anhydride-aromatic vinyl copolymer; about 8 to about 40 parts by weight of glass fibers; and about 10 to about 40 parts by weight of a phosphorus flame retardant, wherein the epoxy group-containing vinyl copolymer and the maleic anhydride-aromatic vinyl copolymer are present in a weight ratio of about 1:0.05 to about 1:0.5. The thermoplastic resin composition has good properties in terms of impact resistance, flame retardancy, heat resistance, fluidity, appearance characteristics, and the like.

### TECHNICAL FIELD

The present invention relates to a thermoplastic resin composition and a molded article produced therefrom. More particularly, the present invention relates to a thermoplastic resin composition that exhibits good properties in terms of impact resistance, flame retardancy, heat resistance, fluidity, appearance characteristics, and the like, and a molded article produced therefrom.

### BACKGROUND ART

As a thermoplastic resin, a rubber-modified aromatic vinyl copolymer resin, such as an acrylonitrile-butadiene-styrene copolymer resin (ABS resin) and the like, has good properties in terms of mechanical properties, processability, and appearance characteristics, and the like to be advantageously applied to interior/exterior materials for electric/electronic products, interior/exterior materials for automobiles, exterior materials for buildings, and the like.

When inorganic fillers including glass fibers and a flame retardant are blended with the rubber-modified aromatic vinyl copolymer resin in order to improve rigidity and flame retardancy of the rubber-modified aromatic vinyl copolymer resin, there can be a problem of deterioration in impact resistance and compatibility between the rubber-modified aromatic vinyl copolymer resin and the inorganic fillers.

Although a method of increasing the molecular weight of the rubber-modified aromatic vinyl copolymer resin can be used in order to improve impact resistance thereof, this method can cause deterioration in appearance characteristics such as protrusion of the inorganic fillers from a surface of a molded article due to decrease in fluidity and lack of moldability.

Therefore, there is a need for development of a thermoplastic resin composition having good properties in terms of impact resistance, flame retardancy, heat resistance, fluidity, appearance characteristics, and the like without causing such problems.

The background technique of the present invention is disclosed in Korean Patent Laid-open Publication No. 2007-0004726 and the like.

### DISCLOSURE

### Technical Problem

It is one object of the present invention to provide a thermoplastic resin composition having good properties in terms of impact resistance, flame retardancy, heat resistance, fluidity, appearance characteristics, and the like.

It is another object of the present invention to provide a molded article produced from the thermoplastic resin composition.

The above and other objects of the present invention can be achieved by the present invention described below.

### Technical Solution

1. One aspect of the present invention relates to a thermoplastic resin composition. The thermoplastic resin composition includes: about 100 parts by weight of a rubber-modified aromatic vinyl copolymer resin; about 5 to about 20 parts by weight of an epoxy group-containing vinyl copolymer; about 0.5 to about 5 parts by weight of a maleic anhydride-aromatic vinyl copolymer; about 8 to about 40 parts by weight of glass fibers; and about 10 to about 40 parts by weight of a phosphorus flame retardant, wherein the epoxy group-containing vinyl copolymer and the maleic anhydride-aromatic vinyl copolymer are present in a weight ratio of about 1:0.05 to about 1:0.5.

2. In Embodiment 1, the rubber-modified aromatic vinyl copolymer resin may include about 10 wt % to about 50 wt % of a rubber-modified vinyl graft copolymer and about 50 wt % to about 90 wt % of an aromatic vinyl copolymer resin.

3. In Embodiment 1 or 2, the aromatic vinyl copolymer resin may be obtained through polymerization of a monomer mixture including an aromatic vinyl monomer and a vinyl cyanide monomer.

4. In Embodiments 1 to 3, the epoxy group-containing vinyl copolymer may be obtained through polymerization of an epoxy group-containing (meth)acrylate, an aromatic vinyl monomer and a monomer copolymerizable with the aromatic vinyl monomer.

5. In Embodiments 1 to 4, the epoxy group-containing vinyl copolymer may include about 0.01 mol % to about 10 mol % of the epoxy group-containing (meth)acrylate.

6. In Embodiments 1 to 5, the maleic anhydride-aromatic vinyl copolymer may be obtained through polymerization of about 5 wt % to about 40 wt % of maleic anhydride and about 60 wt % to about 95 wt % of an aromatic vinyl monomer.

7. In Embodiments 1 to 6, a weight ratio of the total sum of the epoxy group-containing vinyl copolymer and the maleic anhydride-aromatic vinyl copolymer to the glass fibers may be in the range of about 1:0.5 to about 1:4.

8. In Embodiments 1 to 7, a weight ratio of the total sum of the epoxy group-containing vinyl copolymer and the maleic anhydride-aromatic vinyl copolymer to the phosphorus flame retardant may be in the range of about 1:1 to about 1:2.5.

9. In Embodiments 1 to 8, the thermoplastic resin composition may have a notched Izod impact strength of about 4 kgf·cm/cm to about 10 kgf·cm/cm, as measured on a ⅛″ thick specimen in accordance with ASTM D256.

10. In Embodiments 1 to 9, the thermoplastic resin composition may have a flame retardancy of V−2 or higher, as measured on a 0.75 mm thick specimen and a 2.5 mm thick specimen in accordance with the UL-94 standard.

11. In Embodiments 1 to 10, the thermoplastic resin composition may have a Vicat softening temperature of about 80° C. to about 100° C., as measured under a load of 5 kg at 50° C./hr in accordance with ISO 306.

12. In Embodiments 1 to 11, the thermoplastic resin composition may have a melt-flow index (MI) of about 5 g/10 min to about 15 g/10 min, as measured under a load of 5 kg and 200° C. in accordance with ASTM D1238.

13. In Embodiments 1 to 12, the thermoplastic resin composition may have a gloss of about 90% to about 95%, as measured at an angle of 60° in accordance with ASTM D523.

14. In Embodiments 1 to 13, the thermoplastic resin composition may satisfy the following relations 1 to 3.

[Relation 1]

4.5 kgf·cm/cm≤Iz≤9 kgf·cm/cm

where Iz denotes notched Izod impact strength measured on a ⅛″ thick specimen in accordance with ASTM D256.

[Relation 2]

81° C.≤Tv≤90° C.

where Tv denotes a Vicat softening temperature measured under a load of 5 kg at 50° C./hr in accordance with ISO 306.

[Relation 3]

6 g/10 min≤MI≤15 g/10 min

where MI denotes a melt-flow index measured under a load of 5 kg and 200° C. in accordance with ASTM D1238.

15. Another aspect of the present invention relates to a molded article. The molded article is produced from the thermoplastic resin composition according to any one of Embodiments 1 to 14.

### Advantageous Effects

The present invention provides a thermoplastic resin composition having good properties in terms of impact resistance, flame retardancy, heat resistance, fluidity, appearance characteristics, and the like, and a molded article produced therefrom.

### BEST MODE

Hereinafter, embodiments of the present invention will be described in detail.

A thermoplastic resin composition according to the present invention includes: (A) a rubber-modified aromatic vinyl copolymer resin; (B) an epoxy group-containing vinyl copolymer; (C) a maleic anhydride-aromatic vinyl copolymer; (D) glass fibers; and (E) a phosphorus flame retardant.

As used herein to represent a specific numerical range, the expression “a to b” means “≥a and ≤b”.

(A) Rubber-Modified Aromatic Vinyl Copolymer Resin

A rubber-modified aromatic vinyl copolymer resin according to one embodiment of the present invention may include (A1) a rubber-modified vinyl graft copolymer and (A2) an aromatic vinyl copolymer resin.

(A1) Rubber-Modified Vinyl Graft Copolymer

The rubber-modified vinyl graft copolymer according to one embodiment of the present invention may be obtained through graft polymerization of a monomer mixture including an aromatic vinyl monomer and a vinyl cyanide monomer to a rubber polymer. For example, the rubber-modified vinyl graft copolymer may be obtained through graft polymerization of the monomer mixture including the aromatic vinyl monomer and the vinyl cyanide monomer to the rubber polymer and, optionally, the monomer mixture may further include a monomer for imparting processability and heat resistance. Here, polymerization may be performed by any suitable polymerization method known in the art, such as emulsion polymerization, suspension polymerization, and the like. Further, the rubber-modified vinyl graft copolymer may have a core-shell structure in which the rubber polymer constitutes the core and a copolymer of the monomer mixture constitutes the shell, without being limited thereto.

In some embodiments, the rubber polymer may include diene rubbers, such as polybutadiene, poly(styrene-butadiene), and poly(acrylonitrile-butadiene), saturated rubbers obtained by adding hydrogen to the diene rubbers, isoprene rubbers, C₂ to C₁₀ alkyl (meth)acrylate rubbers, copolymers of C₂ to C₁₀ alkyl (meth)acrylate rubbers and styrene, ethylene-propylene-diene terpolymer (EPDM), and the like. These may be used alone or as a mixture thereof. For example, the rubber polymer may include diene rubbers, (meth)acrylate rubbers, specifically butadiene rubbers, butyl acrylate rubbers, and the like.

In some embodiments, the rubber polymer (rubber particles) may have an average (z-average) particle diameter of about 0.05 μm to about 6 μm, for example, about 0.15 μm to about 4 μm, specifically about 0.25 μm to about 3.5 μm. Within this range, the thermoplastic resin composition can have good impact resistance and appearance characteristics. Here, the average (Z-average) particle diameter of the rubber polymer (rubber particles) may be measured by a light scattering method in a latex state. Specifically, a rubber polymer latex is filtered through a mesh to remove coagulum generated during polymerization of the rubber polymer. Then, a mixed solution of 0.5 g of the latex and 30 ml of distilled water is placed in a 1,000 ml flask, which in turn is filled with distilled water to prepare a specimen. Then, 10 ml of the specimen is transferred to a quartz cell, followed by measurement of the average particle diameter of the rubber polymer using a light scattering particle analyzer (Malvern Co., Ltd., Nano-zs).

In some embodiments, the rubber polymer may be present in an amount of about 20 wt % to about 70 wt %, for example, about 25 wt % to about 60 wt %, based on 100 wt % of the rubber-modified vinyl graft copolymer, and the monomer mixture (including the aromatic vinyl monomer and the vinyl cyanide monomer) may be present in an amount of about 30 wt % to about 80 wt %, for example, about 40 wt % to about 75 wt %, based on 100 wt % of the rubber-modified vinyl graft copolymer. Within this range, the thermoplastic resin composition can have good properties in terms of impact resistance, appearance characteristics, and the like.

In some embodiments, the aromatic vinyl monomer may be graft copolymerizable with the rubber polymer and may include, for example, styrene, α-methyl styrene, β-methylstyrene, p-methyl styrene, p-t-butylstyrene, ethyl styrene, vinylxylene, monochlorostyrene, dichlorostyrene, dibromostyrene, vinyl naphthalene, and the like. These may be used alone or as a mixture thereof. The aromatic vinyl monomer may be present in an amount of about 10 wt % to about 90 wt %, for example, about 40 wt % to about 90 wt %, based on 100 wt % of the monomer mixture. Within this range, the thermoplastic resin composition can have good properties in terms of processability, impact resistance, and the like.

In some embodiments, the vinyl cyanide monomer is a monomer copolymerizable with the aromatic vinyl monomer and may include, for example, acrylonitrile, methacrylonitrile, ethacrylonitrile, phenyl acrylonitrile, α-chloroacrylonitrile, and fumaronitrile, without being limited thereto. These may be used alone or as a mixture thereof. For example, the vinyl cyanide monomer may be acrylonitrile, methacrylonitrile, and the like. The vinyl cyanide monomer may be present in an amount of about 10 wt % to about 90 wt %, for example, about 10 wt % to about 60 wt %, based on 100 wt % of the monomer mixture. Within this range, the thermoplastic resin composition can have good properties in terms of chemical resistance, mechanical properties, and the like.

In some embodiments, the monomer for imparting processability and heat resistance may include, for example, (meth)acrylic acid, maleic anhydride, and N-substituted maleimide, without being limited thereto. The monomer for imparting processability and heat resistance may be present in an amount of about 15 wt % or less, for example, about 0.1 wt % to about 10 wt %, based on 100 wt % of the monomer mixture. Within this range, the monomer for imparting processability and heat resistance can impart processability and heat resistance to the thermoplastic resin composition without deterioration in other properties.

In some embodiments, the rubber-modified vinyl graft copolymer may include a copolymer (g-ABS) obtained by grafting a styrene monomer as the aromatic vinyl compound and an acrylonitrile monomer as the vinyl cyanide compound to a butadiene rubber polymer, an acrylate-styrene-acrylonitrile graft copolymer (g-ASA) obtained by grafting a styrene monomer as the aromatic vinyl compound and an acrylonitrile monomer as the vinyl cyanide compound to a butyl acrylate rubber polymer, and the like.

In some embodiments, the rubber-modified vinyl graft copolymer (A1) may be present in an amount of about 10 wt % to about 50 wt %, for example, about 15 wt % to about 45 wt %, based on 100 wt % of the rubber-modified aromatic vinyl copolymer resin (A). Within this range, the thermoplastic resin composition can exhibit good properties impact resistance, molding processability, and the like.

(A2) Aromatic Vinyl Copolymer Resin

The aromatic vinyl copolymer resin according to one embodiment of the present invention may include an aromatic vinyl copolymer resin used in typical rubber-modified aromatic vinyl copolymer resins. For example, the aromatic vinyl copolymer resin may be a polymer of a monomer mixture including an aromatic vinyl monomer and a vinyl cyanide monomer.

In some embodiments, the aromatic vinyl copolymer resin may be obtained by mixing the aromatic vinyl monomer with the vinyl cyanide monomer, followed by polymerization of the mixture. Here, polymerization may be performed by any suitable polymerization method known in the art, such as emulsion polymerization, suspension polymerization, bulk polymerization, and the like.

In some embodiments, the aromatic vinyl monomer may include styrene, α-methyl styrene, β-methylstyrene, p-methyl styrene, p-t-butylstyrene, ethyl styrene, vinylxylene, monochlorostyrene, dichlorostyrene, dibromostyrene, and vinyl naphthalene, without being limited thereto. These may be used alone or as a mixture thereof. The aromatic vinyl monomer may be present in an amount of about 20 wt % to about 90 wt %, for example, about 30 wt % to about 80 wt %, based on 100 wt % of the aromatic vinyl copolymer resin. Within this range, the thermoplastic resin composition can have good properties in terms of impact resistance, fluidity, appearance characteristics, and the like.

In some embodiments, the vinyl cyanide monomer may include acrylonitrile, methacrylonitrile, ethacrylonitrile, phenyl acrylonitrile, α-chloroacrylonitrile, and fumaronitrile, without being limited thereto. These may be used alone or as a mixture thereof. For example, the vinyl cyanide monomer may include acrylonitrile, methacrylonitrile, and the like. The vinyl cyanide monomer may be present in an amount of about 10 wt % to about 90 wt %, for example, about 20 wt % to about 70 wt %, based on 100 wt % of the aromatic vinyl copolymer resin. Within this range, the thermoplastic resin composition can have good properties in terms of impact resistance, fluidity, heat resistance, appearance characteristics, and the like.

In some embodiments, the aromatic vinyl copolymer resin may further include a monomer for imparting processability and heat resistance to the monomer mixture. The monomer for imparting processability and heat resistance may include, for example, (meth)acrylic acid and N-substituted maleimide, without being limited thereto. The monomer for imparting processability and heat resistance may be present in an amount of about 15 wt % or less, for example, about 0.1 wt % to about 10 wt %, based on 100 wt % of the monomer mixture. Within this range, the monomer for imparting processability and heat resistance can impart processability and heat resistance to the thermoplastic resin composition without deterioration in other properties.

In some embodiments, the aromatic vinyl copolymer resin may have a weight average molecular weight (Mw) of about 10,000 g/mol to about 300,000 g/mol, for example, about 15,000 g/mol to about 150,000 g/mol, as measured by gel permeation chromatography (GPC). Within this range, the thermoplastic resin composition can have good mechanical strength, moldability, and the like.

In some embodiments, the aromatic vinyl copolymer resin (A2) may be present in an amount of about 50 wt % to about 90 wt %, for example, about 55 wt % to about 85 wt %, based on 100 wt % of the rubber-modified aromatic vinyl copolymer resin (A). Within this range, the thermoplastic resin composition can exhibit good properties in terms of impact resistance, molding processability, appearance characteristics, and the like.

(B) Epoxy Group-Containing Vinyl Copolymer

The epoxy group-containing vinyl copolymer according to the present invention serves to maximize improvement in properties of each of components contained in the thermoplastic resin composition by improving miscibility between the components of the thermoplastic resin composition together with the maleic anhydride-aromatic vinyl copolymer.

In some embodiments, the epoxy group-containing vinyl copolymer is a resin prepared to have an unsaturated epoxy group in a vinyl polymer and may be prepared through polymerization of a monomer mixture including an epoxy group-containing unsaturated epoxy compound and a vinyl compound. Here, polymerization may be performed by any suitable polymerization method known in the art, such as emulsion polymerization, suspension polymerization, bulk polymerization, and the like.

In some embodiments, the epoxy group-containing unsaturated epoxy compound may include epoxy group-containing (meth)acrylates, such, as glycidyl methacrylate, glycidyl acrylate, and the like. These may be used alone or as a mixture thereof. The epoxy group-containing unsaturated epoxy compound may be present in an amount of about 0.01 mol % to about 10 mol %, for example, about 0.05 mol % to about 5 mol %, specifically about 0.1 mol % to about 2 mol %, based on 100 mol % of the epoxy group-containing vinyl copolymer. Within this range, the epoxy group-containing vinyl copolymer can secure good miscibility between the components of the thermoplastic resin composition while securing good heat resistance, impact resistance, and the like.

In some embodiments, the vinyl compound may include an aromatic vinyl monomer and a monomer copolymerizable with the aromatic vinyl monomer. The vinyl compound may be present in an amount of about 90 mol % to about 99.99 mol %, for example, about 95 mol % to about 99.95 mol %, specifically about 98 mol % to about 99.9 mol %, based on 100 mol % of the epoxy group-containing vinyl copolymer. Within this range, the epoxy group-containing vinyl copolymer can secure good miscibility between the components of the thermoplastic resin composition while securing good fluidity, impact resistance, and the like.

In some embodiments, the aromatic vinyl monomer may include styrene, α-methyl styrene, β-methylstyrene, p-methyl styrene, p-t-butylstyrene, ethyl styrene, vinylxylene, monochlorostyrene, dichlorostyrene, dibromostyrene, vinyl naphthalene, and the like. These may be used alone or as a mixture thereof. The aromatic vinyl monomer may be present in an amount of about 40 wt % to about 95 wt %, for example, about 40 wt % to about 90 wt %, based on 100 wt % of the vinyl compound.

In some embodiments, the monomer copolymerizable with the aromatic vinyl monomer may be a vinyl cyanide compound, for example, acrylonitrile, methacrylonitrile, ethacrylonitrile, phenyl acrylonitrile, α-chloroacrylonitrile, and fumaronitrile, without being limited thereto. These may be used alone or as a mixture thereof. The monomer copolymerizable with the aromatic vinyl monomer may be present in an amount of about 5 wt % to about 60 wt %, for example, about 10 wt % to about 60 wt %, based on 100 wt % of the vinyl compound.

In some embodiments, the epoxy group-containing vinyl copolymer may have a weight average molecular weight (Mw) of about 50,000 g/mol to about 200,000 g/mol, for example, about 100,000 g/mol to about 150,000 g/mol, as measured by gel permeation chromatography (GPC). Within this range, the thermoplastic resin composition can have good fluidity, impact resistance, and the like.

In some embodiments, the epoxy group-containing vinyl copolymer may be present in an amount of about 5 to about 20 parts by weight, for example, about 10 to about 18 parts by weight, relative to about 100 parts by weight of the rubber-modified aromatic vinyl copolymer resin. If the content of the epoxy group-containing vinyl copolymer is less than about 5 parts by weight relative to about 100 parts by weight of the rubber-modified aromatic vinyl copolymer resin, the thermoplastic resin composition can suffer from deterioration in appearance characteristics, flame retardancy, impact resistance, and the like, and if the content thereof exceeds about 20 parts by weight, the thermoplastic resin composition can suffer from deterioration in fluidity, impact resistance, and the like.

(C) Maleic Anhydride-Aromatic Vinyl Copolymer

The maleic anhydride-aromatic vinyl copolymer according to the present invention serves to maximize improvement in properties of each of components contained in the thermoplastic resin composition by improving miscibility between the components of the thermoplastic resin composition together with the epoxy group-containing vinyl copolymer, and is a polymer of maleic anhydride and an aromatic vinyl monomer.

In some embodiments, the maleic anhydride-aromatic vinyl copolymer may be prepared through polymerization of a monomer mixture comprising maleic anhydride and an aromatic vinyl monomer. Here, polymerization may be performed by any suitable polymerization method known in the art, such as emulsion polymerization, suspension polymerization, bulk polymerization, and the like.

In some embodiments, the aromatic vinyl monomer may include styrene, α-methyl styrene, β-methylstyrene, p-methyl styrene, p-t-butylstyrene, ethyl styrene, vinylxylene, monochlorostyrene, dichlorostyrene, dibromostyrene, vinyl naphthalene, and the like. These may be used alone or as a mixture thereof.

In some embodiments, the maleic anhydride may be present in an amount of about 5 wt % to about 40 wt %, for example, about 10 wt % to about 35 wt %, based on 100 wt % of the maleic anhydride-aromatic vinyl copolymer, and the aromatic vinyl monomer may be present in an amount of about 60 wt % to about 95 wt %, for example, about 65 wt % to about 90 wt %, based on 100 wt % of the maleic anhydride-aromatic vinyl copolymer. Within this range, the thermoplastic resin composition can exhibit good heat resistance, impact resistance, and the like.

In some embodiments, the maleic anhydride-aromatic vinyl copolymer may have a weight average molecular weight (Mw) of about 50,000 g/mol to about 150,000 g/mol, for example, about 60,000 g/mol to about 120,000 g/mol, as measured by GPC. Within this range, the thermoplastic resin composition can have good fluidity, impact resistance, and the like.

In some embodiments, the maleic anhydride-aromatic vinyl copolymer may be present in an amount of about 0.5 to about 5 parts by weight, for example, about 1 to about 4.5 parts by weight, relative to about 100 parts by weight of the rubber-modified aromatic vinyl copolymer resin. If the content of the maleic anhydride-aromatic vinyl copolymer is less than about 0.5 parts by weight relative to about 100 parts by weight of the rubber-modified aromatic vinyl copolymer resin, the thermoplastic resin composition can suffer from deterioration in appearance characteristics, heat resistance, impact resistance, and the like, and if the content thereof exceeds about 5 parts by weight, the thermoplastic resin composition can suffer from deterioration in fluidity, appearance characteristics, and the like.

In some embodiments, a weight ratio (B:C) of the epoxy group-containing vinyl copolymer (B) to the maleic anhydride-aromatic vinyl copolymer (C) may be in the range of about 1:0.05 to about 1:0.5, for example, about 1:0.07 to about 1:0.4, specifically about 1:0.1 to about 1:0.3. If the weight ratio of the epoxy group-containing vinyl copolymer to the maleic anhydride-aromatic vinyl copolymer is less than about 1:0.05, the thermoplastic resin composition can suffer from deterioration in appearance characteristics, impact resistance, and the like, and if the weight ratio thereof exceeds about 1:0.5, the thermoplastic resin composition can suffer from deterioration in fluidity, flame retardancy, and the like.

(D) Glass Fibers

The glass fibers according to one embodiment of the present invention serve to improve rigidity, heat resistance and the like of the thermoplastic resin composition, and may be selected from glass fibers used in a typical thermoplastic resin composition.

In some embodiments, the glass fibers may have a fibrous shape and may have various cross-sectional shapes, such as circular, elliptical, and rectangular shapes. For example, fibrous glass fibers having circular and/or rectangular cross-sectional shapes may be preferred in terms of mechanical properties.

In some embodiments, the glass fibers having a circular cross-section may have a cross-sectional diameter of about 5 μm to about 20 μm and a pre-processing length of about 2 mm to about 20 mm, and the glass fibers having a rectangular cross-section may have an aspect ratio (a ratio of a long-side length to a short-side length in a cross-section of the glass fiber) of about 1.5 to about 10, a short-side length of about 2 μm to about 10 μm, and a pre-processing length of about 2 mm to about 20 mm. Within this range, the thermoplastic resin composition can have good properties in terms of rigidity, heat resistance and the like.

In some embodiments, the glass fibers may be subjected to surface treatment with a typical surface treatment agent.

In some embodiments, the glass fibers may be present in an amount of about 8 to about 40 parts by weight, for example, about 10 to about 35 parts by weight, relative to about 100 parts by weight of the rubber-modified aromatic vinyl copolymer resin. If the content of the glass fibers is less than about 8 parts by weight relative to about 100 parts by weight of the rubber-modified aromatic vinyl copolymer resin, the thermoplastic resin composition can suffer from deterioration in rigidity, heat resistance, and the like, and if the content thereof exceeds about 40 parts by weight, the thermoplastic resin composition can suffer from deterioration in appearance characteristics, impact resistance, and the like.

In some embodiments, a weight ratio (B+C:D) of the total sum of the epoxy group-containing vinyl copolymer (B) and the maleic anhydride-aromatic vinyl copolymer (C) to the glass fibers (D) may be in the range of about 1:0.5 to about 1:4, for example, about 1:0.9 to about 1:3. Within this range, the thermoplastic resin composition can have good properties in terms of impact resistance, fluidity, heat resistance, appearance characteristics, and the like.

(E) Phosphorus Flame Retardant

The phosphorus flame retardant according to one embodiment of the present invention may be a phosphorus flame retardant used in typical thermoplastic resin compositions. For example, the phosphorus flame retardant may include a phosphate compound, a phosphonate compound, a phosphinate compound, a phosphine oxide compound, a phosphazene compound, metal salts thereof, and mixtures thereof.

In some embodiments, the phosphorus flame retardant may include an aromatic phosphoric ester compound represented by Formula 1.

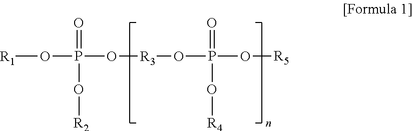

where R₁, R₂, R₄, and R₅ are each independently a hydrogen atom, a C₆ to C₂₀ (6 to 20 carbon atoms) aryl group, or a C₁ to C₁₀ alkyl group-substituted C₆ to C₂₀ aryl group; R₃ is a C₆ to C₂₀ arylene group or a C₁ to C₁₀ alkyl group-substituted C₆ to C₂₀ arylene group, for example, derivatives of a dialcohol, such as resorcinol, hydroquinone, bisphenol-A, or bisphenol-S; and n is an integer of 0 to 10, for example, 0 to 4.

When n is 0 in Formula 1, examples of the aromatic phosphoric ester compound may include diaryl phosphates, such as diphenyl phosphate and the like, triphenyl phosphate, tricresyl phosphate, trixylenyl phosphate, tri(2,6-dimethylphenyl) phosphate, tri(2,4,6-trimethylphenyl) phosphate, tri(2,4-di-tert-butylphenyl) phosphate, and tri(2,6-dimethylphenyl) phosphate; and when n is 1 in Formula 1, examples of the aromatic phosphoric ester compound may include bisphenol-A bis(diphenyl phosphate), resorcinol bis(diphenyl phosphate), resorcinol bis[bis(2,6-dimethylphenyl)phosphate], resorcinol bis[bis(2,4-di-tert-butylphenyl)phosphate], hydroquinone bis[bis(2,6-dimethylphenyl)phosphate], and hydroquinone bis[bis(2,4-di-tert-butylphenyl)phosphate], without being limited thereto. These compounds may be used alone or as a mixture thereof.

In some embodiments, the phosphorus flame retardant may be present in an amount of about 10 to about 40 parts by weight, for example, about 15 to about 35 parts by weight, relative to 100 parts by weight of the rubber-modified aromatic vinyl copolymer resin. If the content of the phosphorus flame retardant is less than about 10 parts by weight relative to about 100 parts by weight of the rubber-modified aromatic vinyl copolymer resin, the thermoplastic resin composition can suffer from deterioration in flame retardancy, fluidity, and the like, and if the content thereof exceeds about 40 parts by weight, the thermoplastic resin composition can suffer from deterioration in heat resistance, impact resistance and the like.

In some embodiments, a weight ratio (B+C:E) of the total sum of the epoxy group-containing vinyl copolymer (B) and the maleic anhydride-aromatic vinyl copolymer (C) to the phosphorus flame retardant (E) may be in the range of about 1:1 to about 1:2.5, for example, about 1:1.3 to about 1:2. Within this range, the thermoplastic resin composition can have good properties in terms of flame retardancy, heat resistance, appearance characteristics, fluidity, and the like.

The thermoplastic resin composition according to one embodiment of the present invention may further include additives used for typical thermoplastic resin compositions. Examples of the additives may include anti-dripping agents, such as fluorinated olefin resins and the like, lubricants, nucleating agents, stabilizers, release agents, pigments, dyes, and mixtures thereof, without being limited thereto. The additives may be present in an amount of about 0.001 to about 40 parts by weight, for example, about 0.1 to about 10 parts by weight, relative to about 100 parts by weight of the thermoplastic resin.

The thermoplastic resin composition according to one embodiment of the present invention may be prepared in pellet form by mixing the aforementioned components, followed by melt extrusion at about 200° C. to about 280° C., for example, about 220° C. to about 260° C., using a typical twin-screw extruder.

In some embodiments, the thermoplastic resin composition may have a notched Izod impact strength of about 4 kgf·cm/cm to about 10 kgf·cm/cm, for example, about 4.5 kgf·cm/cm to about 9 kgf·cm/cm, as measured on a ⅛″ thick specimen in accordance with ASTM D256.

In some embodiments, the thermoplastic resin composition may have a flame retardancy of V−2 or higher, as measured on a 0.75 mm thick specimen and a 2.5 mm thick specimen in accordance with the UL-94 standard.

In some embodiments, the thermoplastic resin composition may have a Vicat softening temperature of about 80° C. to about 100° C., for example, about 81° C. to about 90° C., as measured under a load of 5 kg at 50° C./hr in accordance with ISO 306.

In some embodiments, the thermoplastic resin composition may have a melt-flow index (MI) of about 5 g/10 min to about 15 g/10 min, for example, about 6 g/10 min to about 15 g/10 min, specifically about 7 g/10 min to about 10 g/10 min, as measured under conditions of 200° C. and a load of 5 kg in accordance with ASTM D1238.

In some embodiments, the thermoplastic resin composition may have a gloss of about 90% to about 95%, for example, about 91% to about 94%, as measured at an angle of 60° in accordance with ASTM D523.

In some embodiments, the thermoplastic resin composition may satisfy all of the following relations 1 to 3.

[Relation 1]

4.5 kgf·cm/cm≤Iz≤9 kgf·cm/cm

where Iz denotes notched Izod impact strength measured on a ⅛″ thick specimen in accordance with ASTM D256.

[Relation 2]

81° C.≤Tv≤90° C.

where Tv denotes a Vicat softening temperature measured under a load of 5 kg at 50° C./hr in accordance with ISO 306.

[Relation 3]

6 g/10 min≤MI≤15 g/10 min

where MI denotes a melt-flow index measured under conditions of 200° C. and a load of 5 kg in accordance with ASTM D1238.

A molded article according to the present invention is produced from the thermoplastic resin composition set forth above. The thermoplastic resin composition may be prepared in pellet form. The prepared pellets may be produced into various molded articles (products) by various molding methods, such as injection molding, extrusion molding, vacuum molding, and casting. These molding methods are well known to those skilled in the art. The molded product has good properties in terms of impact resistance, flame retardancy, heat resistance, fluidity, appearance characteristics, and the like, and thus can be advantageously used for interior/exterior materials for buildings and the like.

### MODE FOR INVENTION

Next, the present invention will be described in more detail with reference to some examples. It should be understood that these examples are provided for illustration only and are not to be construed in any way as limiting the invention.

### EXAMPLE

Details of components used in Examples and Comparative Examples are as follows.

(A) Rubber-Modified Aromatic Vinyl Copolymer Resin

A mixture of 25 wt % of (A1) a rubber-modified aromatic vinyl copolymer and 75 wt % of (A2) an aromatic vinyl copolymer resin was used.

(A1) Rubber-Modified Aromatic Vinyl Copolymer

g-ABS prepared by graft copolymerization of 55 wt % of styrene and acrylonitrile (weight ratio: 75/25) to 45 wt % of butadiene rubbers having a Z-average of 310 nm was used.

(A2) Aromatic Vinyl Copolymer Resin

A SAN resin (weight average molecular weight: 130,000 g/mol) prepared by polymerization of 75 wt % of styrene and 25 wt % of acrylonitrile was used.

(B1) Epoxy Group-Containing Vinyl Copolymer

A glycidyl methacrylate-styrene-acrylonitrile copolymer (GMA-SAN, prepared by polymerization of 0.5 mol % of glycidyl methacrylate and 99.5 mol % of styrene and acrylonitrile (styrene:acrylonitrile (weight ratio)=85:15), weight average molecular weight: 115,000 g/mol) was used.

(B2) Maleimide-Vinyl Copolymer

A PMI-SAN resin (weight average molecular weight: 130,000 g/mol) prepared by polymerization of 20 wt % of N-phenyl maleimide, 65 wt % of styrene and 15 wt % of acrylonitrile was used.

(C) Maleic Anhydride-Aromatic Vinyl Copolymer

A styrene-maleic anhydride copolymer (SMA resin, weight average molecular weight: 80,000 g/mol, styrene/maleic anhydride (weight ratio): 74/26) was used.

(D) Glass Fibers

Glass fibers (Manufacturer: NEG, Product Name: T351) were used.

(E) Phosphorus Flame Retardant

Bisphenol-A diphosphate (Manufacturer: Yoke Chemical, Product Name: YOKE BDP) was used.

### Examples 1 to 7 and Comparative Examples 1 to 7

The above components were mixed in amounts as listed in Tables 1 and 2 and subjected to extrusion at 230° C., thereby preparing pellets. Here, extrusion was performed using a twin-screw extruder (L/D=36, Φ: 45 mm) and the prepared pellets were dried at 80° C. for 2 hours or more and injection-molded in a 6 oz. injection molding machine (molding temperature: 230° C., mold temperature: 60° C.), thereby preparing specimens. The specimens were evaluated as to the following properties by the following method, and results are shown in Tables 1 and 2.

Property Measurement

(1) Notched Izod impact strength (kgf·cm/cm): Notched Izod impact strength was measured on a ⅛″ thick specimen in accordance with ASTM D256

(2) Flame retardancy: Flame retardancy was measured on a 0.75 mm thick specimen and a 2.5 mm thick specimen by a UL-94 vertical test method.

(3) Vicat Softening Temperature (VST) (unit: ° C.): Vicat Softening Temperature was measured on a 6.4 mm thick specimen under a load of 5 kg at 50° C./hr in accordance with ISO 306.

(4) Melt-flow index (MI, unit: g/10 min): Melt-flow index was measured under conditions of 200° C. and 5 a load of kg in accordance with ASTMD1238.

(5) Gloss (unit: %): Gloss was measured on a specimen having a size of 90 mm×50 mm×2 mm at an angle of 60° using a UGV-6P gloss meter (Suga) in accordance with ASTM D523.

TABLE 1

| | | Example | | | | | | |
|---|---|---|---|---|---|---|---|---|
| | | 1 | 2 | 3 | 4 | 5 | 6 | 7 |
| (A) (parts by weight) | | 100 | 100 | 100 | 100 | 100 | 100 | 100 |
| (B1) (parts by weight) | | 14 | 14 | 14 | 10 | 20 | 10 | 10 |
| (B2) (parts by weight) | | — | — | — | — | — | — | — |
| (C) (parts by weight) | | 1.4 | 2.8 | 4.2 | 2.8 | 2.8 | 0.5 | 5 |
| (D) (parts by weight) | | 20 | 20 | 20 | 20 | 20 | 20 | 20 |
| (E) (parts by weight) | | 20 | 20 | 20 | 20 | 20 | 20 | 20 |
| Notched Izod impact | | 5 | 6 | 7 | 5 | 4 | 4 | 9 |
| strength (kgf · cm/cm) | | | | | | | | |
| Flame | 0.75 mm | V-2 | V-2 | V-2 | V-2 | V-2 | V-2 | V-2 |
| retardancy | 2.5 mm | V-2 | V-2 | V-2 | V-2 | V-2 | V-2 | V-2 |

| | | | | | | | |
|---|---|---|---|---|---|---|---|
| VST (° C.) | 82 | 82 | 83 | 82 | 81 | 80 | 85 |
| MI (g/10 min) | 9 | 8 | 7 | 8 | 8 | 9 | 5 |
| Gloss (%) | 92 | 92 | 92 | 91 | 92 | 90 | 92 |

TABLE 2

| | | Comparative Example | | | | | | |
|---|---|---|---|---|---|---|---|---|
| | | 1 | 2 | 3 | 4 | 5 | 6 | 7 |
| (A) (parts by weight) | | 100 | 100 | 100 | 100 | 100 | 100 | 100 |
| (B1) (parts by weight) | | 1 | 25 | 14 | 14 | 15 | 9 | — |
| (B2) (parts by weight) | | — | — | — | — | — | — | 14 |
| (C) (parts by weight) | | 2.8 | 2.8 | 0.1 | 6 | 0.5 | 5 | 2.8 |
| (D) (parts by weight) | | 20 | 20 | 20 | 20 | 20 | 20 | 20 |
| (E) (parts by weight) | | 20 | 20 | 20 | 20 | 20 | 20 | 20 |
| Notched Izod impact | | 4.2 | 3 | 3 | 9.2 | 3 | 9 | 3.5 |
| strength (kgf · cm/cm) | | | | | | | | |
| Flame | 0.75 mm | Fail | V-2 | V-2 | V-2 | V-2 | Fail | Fail |
| retardancy | 2.5 mm | V-2 | V-2 | V-2 | V-2 | V-2 | V-2 | V-2 |

| | | | | | | | |
|---|---|---|---|---|---|---|---|
| VST (° C.) | 82 | 82 | 74 | 85.5 | 81 | 85 | 85 |
| MI (g/10 min) | 8 | 4.5 | 9.5 | 4 | 8.6 | 4 | 4.5 |
| Gloss (%) | 89 | 92 | 88 | 88 | 89 | 92 | 87 |

From the above results, it could be seen that the thermoplastic resin compositions (Example 1 to 7) of the present invention exhibited good properties in terms of impact resistance, flame retardancy, heat resistance, fluidity, appearance characteristics, and the like.

Conversely, it could be seen that the thermoplastic resin composition of Comparative Example 1 prepared using a smaller amount of the epoxy group-containing vinyl copolymer exhibited deterioration in appearance characteristics, flame retardancy, and the like; the thermoplastic resin composition of Comparative Example 2 prepared using an excess of the epoxy group-containing vinyl copolymer exhibited deterioration in fluidity, impact resistance, and the like; the thermoplastic resin composition of Comparative Example 3 prepared using a smaller amount of the maleic anhydride-aromatic vinyl copolymer exhibited deterioration in appearance characteristics, heat resistance, impact resistance and the like; and the thermoplastic resin composition of Comparative Example 4 prepared using an excess of the maleic anhydride-aromatic vinyl copolymer exhibited deterioration in fluidity, appearance characteristics, and the like. In addition, it could be seen that the thermoplastic resin composition of Comparative Example 1, in which the weight ratio of the epoxy group-containing vinyl copolymer to the maleic anhydride-aromatic vinyl copolymer is less than the weight ratio range according to the present invention, exhibited deterioration in impact resistance, appearance characteristics, and the like; the thermoplastic resin composition of Comparative Example 6, in which the weight ratio of the epoxy group-containing vinyl copolymer to the maleic anhydride-aromatic vinyl copolymer exceeds the weight ratio range according to the present invention, exhibited deterioration in fluidity, flame retardancy, and the like; and the thermoplastic resin composition of Comparative Example 7, in which the maleimide-vinyl copolymer (B2) was used instead of the epoxy group-containing vinyl copolymer (B1), exhibited deterioration in impact resistance, flame retardancy, fluidity, appearance characteristics, and the like.

It should be understood that various modifications, changes, alterations, and equivalent embodiments can be made by those skilled in the art without departing from the spirit and scope of the present invention.

1. A thermoplastic resin composition comprising:
about 100 parts by weight of a rubber-modified aromatic vinyl copolymer resin;
about 5 to about 20 parts by weight of an epoxy group-containing vinyl copolymer;
about 0.5 to about 5 parts by weight of a maleic anhydride-aromatic vinyl copolymer;
about 8 to about 40 parts by weight of glass fibers; and
about 10 to about 40 parts by weight of a phosphorus flame retardant,
wherein the epoxy group-containing vinyl copolymer and the maleic anhydride-aromatic vinyl copolymer are present in a weight ratio of about 1:0.05 to about 1:0.5.

2. The thermoplastic resin composition according to claim 1, wherein the rubber-modified aromatic vinyl copolymer resin comprises about 10 wt % to about 50 wt % of a rubber-modified vinyl graft copolymer and about 50 wt % to about 90 wt % of an aromatic vinyl copolymer resin.

3. The thermoplastic resin composition according to claim 2, wherein the aromatic vinyl copolymer resin is obtained through polymerization of a monomer mixture comprising an aromatic vinyl monomer and a vinyl cyanide monomer.

4. The thermoplastic resin composition according to claim 1, wherein the epoxy group-containing vinyl copolymer is obtained through polymerization of an epoxy group-containing (meth)acrylate, an aromatic vinyl monomer and a monomer copolymerizable with the aromatic vinyl monomer.

5. The thermoplastic resin composition according to claim 4, wherein the epoxy group-containing vinyl copolymer comprises about 0.01 mol % to about 10 mol % of the epoxy group-containing (meth)acrylate.

6. The thermoplastic resin composition according to claim 1, wherein the maleic anhydride-aromatic vinyl copolymer is obtained through polymerization of about 5 wt % to about 40 wt % of maleic anhydride and about 60 wt % to about 95 wt % of an aromatic vinyl monomer.

7. The thermoplastic resin composition according to claim 1, wherein a weight ratio of the total sum of the epoxy group-containing vinyl copolymer and the maleic anhydride-aromatic vinyl copolymer to the glass fibers is in the range of about 1:0.5 to about 1:4.

8. The thermoplastic resin composition according to claim 1, wherein a weight ratio of the total sum of the epoxy group-containing vinyl copolymer and the maleic anhydride-aromatic vinyl copolymer to the phosphorus flame retardant is in the range of about 1:1 to about 1:2.5.

9. The thermoplastic resin composition according to claim 1, wherein the thermoplastic resin composition has a notched Izod impact strength of about 4 kgf·cm/cm to about 10 kgf·cm/cm, as measured on a ⅛″ thick specimen in accordance with ASTM D256.

10. The thermoplastic resin composition according to claim 1, wherein the thermoplastic resin composition has a flame retardancy of V−2 or higher, as measured on a 0.75 mm thick specimen and a 2.5 mm thick specimen in accordance with the UL-94 standard.

11. The thermoplastic resin composition according to claim 1, wherein the thermoplastic resin composition has a Vicat softening temperature of about 80° C. to about 100° C., as measured under a load of 5 kg at 50° C./hr in accordance with ISO 306.

12. The thermoplastic resin composition according to claim 1, wherein the thermoplastic resin composition has a melt-flow index (MI) of about 5 g/10 min to about 15 g/10 min, as measured under conditions of 200° C. and a load of 5 kg in accordance with ASTM D1238.

13. The thermoplastic resin composition according to claim 1, wherein the thermoplastic resin composition has a gloss of about 90% to about 95%, as measured at an angle of 60° in accordance with ASTM D523.

14. The thermoplastic resin composition according to claim 1, wherein the thermoplastic resin composition satisfies all of the following relations 1 to 3:
[Relation 1]
4.5 kgf·cm/cm≤Iz≤9 kgf·cm/cm
wherein Iz denotes notched Izod impact strength measured on a ⅛″ thick specimen in accordance with ASTM D256;
[Relation 2]
81° C.≤Tv≤90° C.
wherein Tv denotes a Vicat softening temperature measured under a load of 5 kg at 50° C./hr in accordance with ISO 306; and
[Relation 3]
6 g/10 min≤MI≤15 g/10 min
wherein MI denotes a melt-flow index measured under conditions of 200° C. and a load of 5 kg in accordance with ASTM D1238.

15. A molded article produced from the thermoplastic resin composition according to claim 1.
